(19) United States
(12) Patent Application Publication
(10) Pub. No.: US 2010/0316797 A1
(43) Pub. Date: Dec. 16, 2010

(54) FORMING GLUTATHIONE-CAPPED AND METAL-DOPED ZINC SELENIDE/ZINC SULFIDE CORE-SHELL QUANTUM DOTS IN AQUEOUS SOLUTION

(76) Inventors: Jackie Y. Ying, Singapore (SG); Yuangang Zheng, Singapore (SG); Yuqiong Li, Singapore (SG)

Correspondence Address: KLARQUIST SPARKMAN, LLP, 121 SW SALMON STREET, SUITE 1600, PORTLAND, OR, 97204, US

(21) Appl. No.: 12/866,234

(22) PCT Filed: Feb. 4, 2009
(86) PCT No.: PCT/SG09/00042

§ 371 Date: Aug. 4, 2010

Related U.S. Application Data
(60) Provisional application No. 61/006,863, filed on Feb. 4, 2008.

(51) Int. Cl. B05D 7/00; B05D 3/02

(52) U.S. Cl. 427/216

(57) ABSTRACT

In a process of forming a capped crystal structure, a precursor solution is heated. The solution comprises a mixture of zinc (Zn) precursor, selenium (Se) precursor, precursor for a dopant, glutathione (GSH), and water. The dopant comprises a transition metal (M). The molar ratio of Zn:Se in the solution may be about 10:3 to about 10:5. The solution is heated for a first period sufficient to allow Zn(M)Se crystal core to form. After the first period of heating, more zinc precursor and GSH are added to the heated solution, and the solution is heated for a second period sufficient to form ZnS crystal shell on the Zn(M)Se crystal core. GSH is added in a sufficient amount to form a GSH layer around the Zn(M)Se/ZnS quantum dot.

### CROSS-REFERENCE TO RELATED APPLICATION

This application claims the benefit of U.S. provisional application No. 61/006,863, filed Feb. 4, 2008, the entire contents of which are incorporated herein by reference.

### FIELD OF THE INVENTION

The present invention relates generally to quantum dots, and particularly to glutathione-capped quantum dots doped with a transition metal, and the related preparation methods.

### BACKGROUND OF THE INVENTION

Cadmium (Cd)-free quantum dots such as copper (Cu) or manganese (Mn) doped zinc selenide (ZnSe) quantum dots, or Cu or Mn doped ZnSe/ZnS (zinc sulfide) core-shell quantum dots can be prepared using organometallic synthesis techniques. These techniques involve heat treatment at high temperatures, typically above 280° C., and use expensive organic solvents or precursor materials.

### SUMMARY OF THE INVENTION

A process for conveniently preparing GSH-capped, transition metal doped ZnSe/ZnS core-shell quantum dots in an aqueous solution at a relatively low temperature has been discovered.

Conveniently, the capped quantum dots may be prepared with GSH and inorganic precursor materials in water at temperatures below the boiling temperature of water. The quantum dots may have a crystal size as small as about 4 nm. The capped quantum dots may have a fluorescence quantum yield of up to 15% or 20%, depending on the dopant. The resulting capped quantum dots may be free of Cadmium.

Thus, in accordance with an aspect of the present invention, there is provided a process of forming a capped doped core-shell crystal structure. The process comprises heating a precursor solution. The precursor solution comprises a mixture of a zinc (Zn) precursor, a selenium (Se) precursor, a precursor for a dopant, glutathione (GSH), and water. The dopant comprises a transition metal (M). The molar ratio of Zn:Se in the solution is about 10:3 to about 10:5, such as about 5:2. The solution is heated for a first period sufficient to allow a zinc selenide (ZnSe) crystal core doped with the dopant (Zn(M)Se) to form in the solution. After the first period of heating, more zinc precursor and GSH are added to the heated solution; and the solution is heated for a second period sufficient to form a ZnS crystal shell on the Zn(M)Se crystal core. The GSH is added in a sufficient amount to form a GSH layer around the crystal structure comprising the Zn(M)Se/Zn crystal core and the ZnS crystal shell on the crystal core, thus forming a GSH capped Zn(M)Se/ZnS quantum dot. The first heating period may be from about 15 to about 30 minutes. The second heating period may be from about two to about four hours.

In accordance with another aspect of the present invention, there is provided a process of forming a capped and doped core-shell crystal structure. The process comprises, sequentially, heating a first, precursor solution comprising a mixture of a first zinc (Zn) precursor, a selenium (Se) precursor, a precursor for a dopant comprising a transition metal (M), glutathione (GSH), and water, to form a zinc selenide crystal core doped with the dopant (Zn(M)Se); adding a second zinc precursor and GSH to the precursor solution to form a second solution; heating the second solution to form a ZnS crystal shell on the Zn(M)Se crystal core, wherein the GSH is added in a sufficient amount to form a layer around the crystal structure comprising the Zn(M)Se/Zn crystal core and the ZnS crystal shell on the crystal core, thus forming a GSH capped Zn(M)Se/ZnS quantum dot. The molar ratio of Zn:Se in the precursor solution may be about 10:3 to about 10:5 such as about 5:2. The precursor solution may be heated for about 15 to about 30 minutes, and the second solution may be heated for about 2 to about 4 hours.

In the processes described herein, the pH of the precursor solution may be from about 10 to about 12. The precursor solution may be prepared by adding the selenium precursor to an aqueous solution, where the aqueous solution comprises a mixture of the zinc precursor, the precursor for the dopant, and GSH. The solution(s) may be heated at a temperature below the boiling temperature of water, such as from about 95 to about 99° C. The zinc precursor may comprise zinc chloride, the selenium precursor may comprise sodium hydroselenide, and the precursor for the dopant may comprise a metal chloride. The molar ratio of Zn to the dopant in the precursor solution may be about 50:1. When adding more zinc precursor and GSH to the heated precursor solution, the zinc precursor and GSH may be added at a rate selected to favor growth of ZnS crystals on the Zn(M)Se crystal core over growth of free ZnS crystals. For example, the rate may be about 1 to about 5 ml/min. The transition metal may also comprise copper, manganese, europium, lead, or silver. When the transition metal is copper, the GSH capped quantum dot may have a fluorescence quantum yield of about 15%. The transition metal may be manganese, in which case, the precursor solution may further comprise a sulfur precursor, and the molar ratio of Zn:Se:S in the precursor solution may be about 5:2:3. The sulfur precursor may comprise sodium sulfide. The GSH capped (Mn doped) quantum dot may have a fluorescence quantum yield of about 20%. The crystal structure may be generally spherical and may have a diameter of about 4 to about 5 nm. The GSH capped quantum dot may be generally spherical and may have a diameter of about 6 nm.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate, by way of example only, embodiments of the present invention,

FIG. 1 is a schematic diagram illustrating a process for forming capped and doped quantum dots, exemplary of an embodiment of the present invention;

FIG. 2 is a schematic diagram of a capped and doped quantum dot produced by the process of FIG. 1;

FIGS. 3 and 4 are line graphs showing measured absorbance and fluorescence spectra of samples prepared according to an exemplary embodiment of the present invention;

FIGS. 5 and 6 are line graphs showing the particle size distributions as measured by dynamic light scattering (DLS) in sample quantum dots;

FIG. 7 is a line graph showing the powder X-ray diffraction (PXRD) patterns measured from sample quantum dots; and

FIGS. 8, 9, 10, and 11 are transmission electron microscopy (TEM) images of sample quantum dots.

### DETAILED DESCRIPTION OF EXEMPLARY EMBODIMENTS

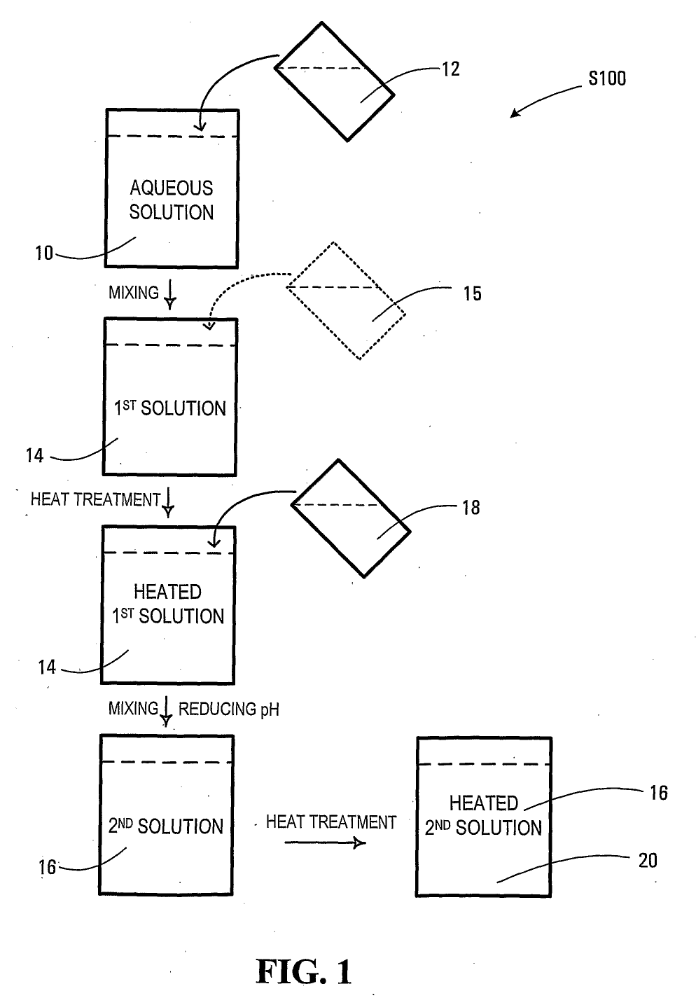

An exemplary embodiment of the present invention relates to a process S100 for preparing glutathione (GSH)-capped and transition metal-doped core-shell quantum dots (QDs), as schematically illustrated in FIG. 1.

In process S100, an aqueous solution 10 is initially prepared which contains a mixture of a zinc (Zn) precursor, a precursor for a dopant, and GSH. The dopant may be a transition metal (M), such as copper (Cu) or manganese (Mn). After the zinc precursor and the dopant precursor are premixed, a selenium (Se) precursor is added to the aqueous solution 10 to form a precursor solution 14. The selenium precursor may be dissolved in water and added as a solution 12. The precursor solution 14 thus contains a mixture of the Zn precursor, the precursor for the dopant, GSH, the Se precursor, and water. The pH of the precursor solution 14 may be about 10 to about 12, such as about 11.5, depending on the respective concentrations of the base and acid materials in the solution.

The precursors may be added in amounts such that the molar ratio of Zn:Se in the precursor solution 14 is about 5:2 and the molar ratio of Zn:dopant in the precursor solution 14 is about 50:1. The GSH in the precursor solution 14 may have a concentration higher than the concentration of the Zn precursor.

Optionally, an anion source may be added to the precursor solution 14 before heating, the benefit of which will become clear below. The anion source may be added as an anion source solution 15.

The solutions 10, 14 may be stirred or otherwise agitated to mix the various ingredients.

The precursor solution 14 is then heated to a suitable temperature for a first suitable period of time, such as about 95° C. for about 15 minutes, to form a zinc selenide (ZnSe) crystal core doped with the dopant, which is denoted as Zn(M)Se herein. The heated solution is stirred during the heat treatment.

After the first period of heating, more zinc precursor and GSH are added to the heated solution 14, without cooling the solution. The solution is heated for a second period after the first period. For easy identification, the precursor solution is referred to as the first precursor solution 14 before adding more zinc and GSH, and as the second (precursor) solution 16 during the second period of heating.

The zinc precursor should be soluble in water. The zinc precursor added after the first period may be the same as the zinc precursor already in the first precursor solution 14, or may be a different zinc precursor. The added zinc precursor and GSH may be added in a top-up solution 18. The respective total molar amounts of the zinc precursor and GSH added may be equivalent to the respective molar amounts of the zinc precursor and GSH in the initial aqueous solution 12.

When the additional zinc precursor and GSH are added to the precursor solution, growth of zinc sulfide (ZnS) crystals is favored over the growth of ZnSe or Zn(M)Se crystals. To favor growth of ZnS crystals on the Zn(M)Se crystal core over growth of free ZnS crystals which are formed separately in the solution, the top-up solution 18 should be added gradually at a low rate, such as about 1 to about 5 ml/min. The rate of addition refers to the average rate. For example, the top-up solution 18 may be added either continuously at the selected rate, or drop-wise such that the average rate equals the selected rate. If the top-up solution 18 is added too fast, the formation of separate ZnS crystal particles will be favored over the growth of ZnS crystal shells on the Zn(M)Se crystal cores.

If the pH in the second precursor solution 16 is too low, it may be increased, for example, by adding a base material such as NaOH. The pH of the second solution 16 may be adjusted to about 10 to about 12, to favor the growth of ZnS crystals.

The second solution 16 is heated at a suitable temperature for a suitable second period of time, such as about 95° C. for about two hours, to form a ZnS crystal shell on the Zn(M)Se crystal core.

After the heat treatment, the heated solution 16 may be allowed to cool to the room temperature.

The crystal structure formed by the Zn(M)Se crystal core and the ZnS crystal shell on it forms a quantum dot when the crystal core and the shell have a suitable size and thickness. For example, the crystal structure may be generally spherical and may have a diameter of about 4 to about 5 nm.

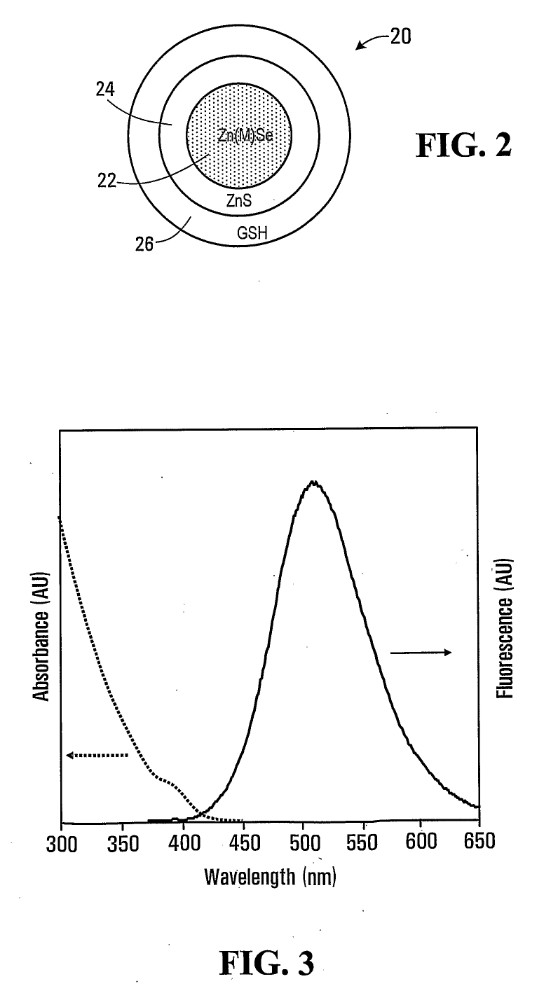

When a sufficient amount of GSH is present in the heated solution, a GSH capping layer will form around the crystal structure. A GSH layer may initially form around the Zn(M)Se crystal core but the ZnS crystal shell may still grow between the GSH layer and the Zn(M)Se crystal core during the second period of heating. The GSH capped crystal structure is referred to as GSH capped quantum dot 20 (not separately shown in FIG. 1, but see FIG. 2).

FIG. 2 schematically illustrates the resulting capped quantum dots 20 formed in the heated second solution 16. As shown in FIG. 2, the capped quantum dot 20 has a Zn(M)Se crystal core 22, a ZnS crystal shell 24 on the core, and a GSH capping layer 26 around the ZnS crystal shell.

The amounts of precursor materials in the solutions are selected to promote formation of the desired crystal structures. For example, in some embodiments, the relative molar ratios of certain materials in the solution may need to be accurately controlled in order to achieve the optimal results.

To optimize the quantum yield (QY) of the resulting product, the Zn:Se molar ratio in the first precursor solution should be about 5:2 before heating. Departure from the ratio of 5:2 leads to reduced QY. However, in different embodiments, the Zn:Se molar ratio may vary by about 20%, or from about 10:3 to about 10:5, and still achieve good QY.

The QY of a given sample can be calculated based on measurements of fluorescence emission and absorbance of the sample and a reference material with a known QY, according to the following equation,

QYₛ=(Fₛ×Aᵣ×QYᵣ)/(Fᵣ×Aₛ), (1)

where QYₛ is the quantum yield of the sample, Fₛ and Fᵣ are respective integrated fluorescence emission of the sample and the reference, Aₛ and Aᵣ are respective absorbance of the sample and the reference at the excitation wavelength, and QYᵣ is the quantum yield of the reference.

Sufficient zinc precursor and GSH should be added after the first period of heating so that the concentrations of free zinc ions and sulfur anions in the second precursor solution 16 substantially exceed the concentration of free selenium ions remaining in the solution, so as to favor the growth of ZnS crystals over ZnSe crystals. The amount of GSH. added should also be sufficient so that a GSH capping layer can form or remain on the crystal particles.

In some embodiments, it may be advantageous to add excessive GSH in the second precursor solution 16, as it may promote crosslinking between the GSH molecules within the same capping layer, and may prevent excessive aggregation of the capped quantum dots.

The absolution molar concentration of each precursor or GSH in the solution may be about 2 to about 50 mM, such as from about 10 to about 20 mM.

To avoid possible contamination and undesired side reactions, the heat treatment of the solutions may be carried out under an inert gas, such as nitrogen or argon. For example, oxygen contamination can significantly reduce the QY in the resulting product.

The heating temperature and heating time for the heat treatment of each precursor solution may vary depending on the desired crystal size, the contents of the solutions, and the solution pH. As the heated solution contains water as a solvent, the temperature of the solution should be kept below the boiling temperature of water. Under a higher environmental pressure, the heating temperature may be higher due to increased water boiling temperature. Generally, at higher temperatures, the rate of nucleation or crystal growth may be faster. However, it has been found that for at least some transition metals, such as Cu and Mn, sufficient nucleation and growth rates may be achieved at a relatively low temperature, such as at about 95 to about 99° C. The heating temperature may be adjusted to control the crystal nucleation or growth rate. For example, when the heating temperature is about 80° C., the time needed to complete the same amount of crystal growth may double as compared to the time needed when the heating temperature is about 95 to about 99° C.

The heating time may be adjusted to control the optical properties of the resulting product, such as its QY, crystal size, the core diameter, or the shell thickness. Typically, the overall heating time may be from about 2 to about 4 hours. The heating time for achieving desired optical properties in the doped QDs may be shortened by increasing the pH in the heated solution. However, increasing pH may result in reduced QY. It has been found that in some embodiments, heating the precursor solution for longer than about 4 hours would not further improve the QY.

With the guidance given here, a person skilled in the art would understand how to select the heating temperature and heating time for a given combination of precursor materials and the desired optical properties of the product.

The dopant may include Cu or Mn, or another transition metal. A transition metal is an element whose atom has an incomplete d electron sub-shell, or which can give rise to cations with an incomplete d sub-shell. A transition metal does not include zinc, cadmium, or mercury as used herein. Suitable transition metals may include europium (Eu), lead, or silver.

The dopant precursor may be a metal chloride, such as copper chloride or manganese chloride, depending on the desired dopant.

The zinc precursor may be zinc chloride (ZnCl₂), or any other suitable water-soluble zinc precursor. Other suitable zinc precursors may include zinc acetate, or zinc sulfate, or the like. As discussed above, one type or more types of zinc precursors may be used in the process to provide the zinc ions needed for the nucleation and growth of crystals at different stages of the process.

The selenium precursor may be sodium hydroselenide. Other suitable selenium precursors may also be used. For example, a hydrogen selenide gas may be used as the selenium precursor. A combination of different selenium precursors may also be used.

Conveniently, some of the GSH molecules will decompose in the precursor solution during heating, thus providing the sulfur anions needed for forming the ZnS crystals. Therefore, a separate sulfur precursor is not necessary. In some embodiments, a separate sulfur precursor may be optionally included or added in the first or second precursor solution. For example, potassium sulfide, lithium sulfide, or the like may be used.

In different embodiments, GSH may be replaced with another thiol precursor, for example mecarptoacetic acid. However, as discussed herein, GSH may provide better QY in the final product as compared to other thiol precursors.

Treatment conditions may be varied and further treatment may be included in the process depending on the particular dopant used, as will be illustrated below.

The resulting products prepared from the above process are capped quantum dots doped with the dopant. The quantum dot has a core-shell structure formed from Zn(M)Se crystal core and a ZnS crystal shell on the core. The Zn(M)Se crystal core is doped with the dopant M. A GSH capping layer is formed around the core-shell structure. The molar ratio of Zn to the dopant in the crystal core may be about 50:1. The core-shell structure may be generally spherical and may have a diameter of about 4 to about 5 nm. The capped quantum dot may have a generally spherical shape and a diameter of about 6 nm. The fluorescence quantum yield of the capped quantum dot may be up to about 15% when doped with copper, or 20% when doped with manganese.

In one embodiment, the ZnSe crystal core is to be doped with copper (M=Cu). In this embodiment, the initial aqueous solution 10 contains a mixture of suitable amounts of ZnCl, CuCl, and GSH. After the contents of the initial aqueous solution 10 are sufficiently mixed, a solution 12 containing sodium hydroselenide (NaHSe) is added to the aqueous solution 10 to form the first precursor solution 14. The precursor solution 14 is heated to about 95° C. for about 15 minutes. At this time, Cu-doped ZnSe crystals, Zn(Cu)Se, are formed in the heated solution 14.

In an aqueous solution, the dissociation constant (K_{d}) of CuSe is 3.2×10⁻⁵⁶ and the K_{d} of ZnSe is 1.7×10⁻²⁴. Thus, incorporation of Cu ions into the ZnSe crystal may take place on nucleation.

More ZnCl and GSH are added to the heated solution 14, in a solution 18, to form the second solution 16. The second solution is heated at about 95° C. for about two hours. After the heat treatment, ZnS crystals are grown on the Zn(Cu)Se crystal cores and form ZnS crystal shells. A pair of ZnS crystal shell and Zn(Cu)Se crystal core forms a quantum dot with a core-shell structure. Further, A GSH layer is formed around the ZnS crystal shell thus capping the core-shell structure. The GSH in the solution thus serves as a stabilizer.

During the heat treatment of the second solution 16, a Zn(Cu)Se crystal core may be gradually covered by a few layers of ZnS crystal, which form the crystal shell.

In the resulting GSH-capped Zn(Cu)Se/ZnS quantum dots, the band edge emission of ZnSe crystals at 380 nm may be substantially quenched, but a Cu-doping emission may be observable at about 450 nm.

When the doping concentration is varied, emission properties of the resulting quantum dots also changes. For example, at fess than 1% (by mole) of Cu doping, the band edge emission of ZnSe crystal may coexist with the Cu-doping emission. With 2 wt % (weight percent) of Cu doping, the band edge emission of ZnSe crystal may be completely quenched and replaced by Cu-doping emission. The quantum yield (QY) of the resulting quantum dots may also vary. For example, at 2 wt % Cu-doping, the QY may be about 15%. Further increasing Cu doping may lead to a reduced QY. The doping concentration may be measured using elemental analysis, and can be carried out by one skilled in the art.

The doping percentage may be determined by elemental analysis of the product QDs. The doping percentage may be based on the weight of Cu and the total weight of Zn and Se.

In this embodiment, it is not necessary to add the optional anion source in the first precursor solution 14 before it is heated.

In another embodiment, the dopant is manganese (M=Mn).

In this embodiment, process S100 is followed with an anion source added to the first precursor solution 14 before heating the first precursor solution 14, such as by way of the anion source solution 15.

As the dissociation constant (K_{d}) of MnSe is 2.3×10⁻¹³, which is much higher than that of ZnSe (1.7×10⁻²⁴), the additional ingredient is added to promote the doping of Mn into the ZnSe crystal. It has been found that while reducing the relative concentration of Zn in the solution may facilitate the crystal formation of MnSe and doping of Mn into the ZnSe crystal, the resulting doped Zn(Mn)Se crystal has a much reduced QY, such as less than 1%. Without being limited to a particular theory, it has been postulated that a layer of Zn:thiol complex may be formed on the surface of Zn(Mn)Se crystal core during the growth towards a well-passivated Zn(Mn)Se/ZnS structure. An excess of Se²⁻ ions in the solution may thus interfere with the formation of the ZnS shell crystal on the core crystal, and result in fluorescence quenching.

It has been discovered that the presence of excess anions other than Se²⁻ in the first solution 14 can also promote the doping of Mn into the ZnSe crystal. For this purpose, an anion source for anions other than the Se²⁻ ions, such as sodium sulfide (Na₂S) may be added to the first solution 14 after addition of NaHSe and before the first solution 14 is heated. The anion source should be added slowly. The anion source may be added so that the molar ratio of Zn:Se:S in the first solution 14 before heat treatment is about 5:2:3. As a result, an excess of S²⁻ ion is present in the first solution 14, which facilitates crystallization of both ZnSe(S) and MnSe(S). The introduction of S²⁻ ions can also facilitate the later growth of a layer of ZnS crystal on the surface of Zn(Mn)Se crystals in the second solution 16.

The Zn(M)Se core crystals are grown in the first precursor solution 14 during the first period of heat treatment at about 95° C., for about 30 min. Formation of the Zn(Mn)Se core crystals can be confirmed by the presence of a prominent Mn emission at about 570 to 600 nm, such as about 580 or 590 nm, and a QY of about 3% from the crystals formed after the initial heat treatment.

When the relatively strong basic precursor solution 14 (with pH higher than about 10) is heated, some GSH molecules in the solution will be thermally decomposed, thus releasing S²⁻ ions into the solution. To promote the formation of Zn(Mn)Se/ZnS core-shell crystals, an excess of Zn²⁺ ions, as compared to S²⁻, should be present in the second precursor solution 16. An excess of S²⁻ ions may hinder the formation of the ZnS shell crystals. Thus, more Zn precursor may be slowly added to the heated solution after the first period of heating to produce more Zn²⁺ ions in the second solution 16 during the second period of heating, thus improving or optimizing the crystal growth condition for the final product.

The QY of the final product after the second period of heat treatment of the precursor solution can reach about 20%, which is significantly higher than the 3% QY from the Zn(Mn)Se crystal initially formed.

It has been found that the optimal value of the molar ratio of Zn:Se:S in the first solution 14 is about 5:2:3 in this embodiment. If the amount of the sulfur precursor in the first solution 14 is reduced, the Mn emission in the formed product will be reduced, as less Mn will be doped into the ZnSe crystal. If the amount of the sulfur precursor is too high, the emission signal in the formed product will be quenched. In this embodiment, the sulfur precursor should be added such that the molar ratio of Zn:Se:S in the first solution 14 is more than about 5:2:4 and less than about 5:2:2.

The molar ratio of Zn²⁺:Mn²⁺ in the first solution 14 may vary from about 200:1 to about 20:1. To optimize the QY of the final product, this ratio may be about 50:1. In other words, the optimal dopant molar concentration in the Zn(M)Se crystal is about 2% in this embodiment. If the dopant concentration is too high, the QY of the final product will be quenched. In different embodiments, the optimal concentration may vary.

While other thiol ligands, such as mercaptoacetic acid (MAA), mercaptopropionic acid (MPA) or cysteine, can also work as a capping agent, it has been found that GSH capped, Mn-doped ZnSe/ZnS QDs exhibit much higher QY than Mn-doped ZnSe/ZnS QDs capped by these other capping agents. For example, when the doped QDs are capped with MMA, MPA, or cysteine, their QY is only less than 3%.

GSH capped QDs are also water-soluble and biocompatible, and may be suitable for fluorescent labeling and imaging in biological applications.

The exemplary synthesis processes described herein may be relatively simpler and more cost-effective, as compared to the conventional organometallic processes for preparing transition metal doped QDs.

As discussed above, the exemplary processes described herein may be adapted or modified to prepare other doped crystal structures in an aqueous phase, such as Zn(Mn)S QDs, Zn(Eu)Se QDs, or the like.

The GSH molecules in the GSH layer may be crosslinked. To do so, an activation agent may be included in the second precursor solution, or may be added after the second solution has been subjected to the heat treatment. Crosslinking the GSH capping layer may increase the stability of the resulting capped and doped QDS. Crosslinked GSH-capped QDs can be used as biotags for in vitro and in vivo bioimaging. They can also be used as fluorescent probes for the detection of DNA and proteins. When conjugated with magnetic nanoparticles, they can form nanocomposites capable of simultaneous biolabeling, bioimaging, cell sorting, targeting and separation.

The capped and doped quantum dots prepared according the above processes may be conveniently used in various applications. For example, they may be used for labeling or imaging various targets in different applications. They may be conveniently used in multi-photon fluorescence imaging. The capped quantum dots prepared by the processes described herein may be free of cadmium, and may thus be more biocompatible with various biomedical applications than quantum dots that contain cadmium.

The exemplary embodiments of the invention and their applications are further illustrated by the following examples.

### EXAMPLES

The materials used in the Examples were obtained as follows. Sodium hydroxide, zinc chloride, manganese chloride, and 2-propanol were purchased from Lancaster Synthesis™. L-glutathione, sodium sulfide, selenium powder (200 mesh) and sodium borohydride were purchased from Sigma-Aldrich™.

The reference material for determining sample QYs was a quinine sulfate solution in 50 mM of H₂SO₄. The QY of the reference material was 54.6% at 310 nm excitation wavelength.

### EXAMPLE I

### Synthesis of GSH capped Zn(Cu)Se/ZnS QDs

The synthesis procedure in this example followed the exemplary process described above for Cu doped QDs. The zinc precursor used was ZnCl, and the selenium precursor was sodium hydroselenide. The solvent for the precursor solutions were oxygen-free water, and the solutions were subjected to heat treatment under nitrogen.

An initial aqueous solution was prepared by mixing ZnCl, CuCl₂ and GSH in oxygen-free water. 50 ml of this solution contains 0.5 mmol of Zn, 0.01 mmol of Cu, and 0.2 mmol of Se, and 0.6 mmol of GSH.

Sodium hydroselenide was prepared by mixing sodium borohydride NaBH₄ and selenium powder in water. After the selenium powder was completely reduced by NaBH₄, 10 ml of the freshly prepared NaHSe solution (0.02 M) were added to and mixed with 50 ml of the above initial aqueous solution, forming the first precursor solution. The first precursor solution had a pH or 11.5 and was vigorously stirred.

The resulting first precursor solution was heated to about 95° C., and the growth of crystals was initiated immediately at this temperature. After a period of about 15 min of heating, nanocrystalline Cu-doped Zn(Cu)Se crystals were formed. About 30 ml of a top-up solution containing 0.1 M of ZnCl₂ and a slightly (by about 10 to 20%) higher concentration of GSH was added drop-wise to the heated first solution. The rate of addition was about 1 to about 5 ml/min. The pH in the resulting second solution was adjusted to about 10 with the addition of an appropriate amount of 1 M of NaOH solution. The NaOH solution was added drop-wise to the second solution. The second solution was then subjected to further heat treatment at about 95° C. for a period of about two hours. The QY of Cu emission from the QDs in the solution was gradually increased from about 1% to about 15% at the end of the heat treatment. Heating was terminated when a stable fluorescence emission was achieved.

The QDs in the heated second solution were precipitated by adding a minimal amount of 2-propanol to the heated second solution. The precipitated QDs were re-suspended in a minimal amount of deionized water. Excess salts were removed from the QDS by repeating the precipitation-suspension procedure three times. The purified QDs were vacuum-dried to a powder form, which had a weight of 160 mg. Upon storage in open atmosphere, the sample weight was increased to 250 mg due to the adsorption of water.

This sample is referred to as Sample I herein.

### EXAMPLE II

### Synthesis of GSH capped Zn(Mn)Se/ZnS QDs

The samples in this example were prepared following the exemplary process described above for Mn doped QDs.

The initial aqueous solution and the first precursor solution were prepared as in Example I, except that the dopant precursor was MnCl₂, instead of CuCl₂. The pH of the first precursor solution was 11.5.

Before the heat treatment, 0.3 ml of a sulfur source solution containing 1 M of Na₂S was added to the first precursor solution under vigorous stirring. The amounts of Zn, Mn, Se, S and GSH in 50 ml of the resulting first precursor solution were 0.5, 0.01, 0.2, 0.3 and 0.6 mmol, respectively.

The first precursor solution was subjected to heat treatment at 95° C. for about 5 minutes. The nucleation and growth of crystals were initiated on heating. The fluorescence emission of Zn(Mn)Se crystals at 590 nm was observable after 15 min of heating.

10 ml of the top-up solution as prepared in Example I was added drop-wise to the heated first solution to form the second solution at a rate of about 1 to about 5 ml/min. The pH of the second solution was reduced to 10 by adding dropwise an appropriate amount of the NaOH solution described in Example I.

The second solution was then subjected to heat treatment at 95° C. for two hours.

The QY of Mn emission was gradually increased from 1% to 20% as the ZnS crystal shell and the GSH capping layer were formed on the Zn(Mn)Se crystal core. Heating was terminated when a stable fluorescence emission was achieved.

The formed QDs were extracted from the heated second solution and purified as described Example I. The resulting dried powder of the resulting QDs weighed 160 mg. After being stored in open atmosphere for a few days, the weight of the sample was increased to 250 mg due to the adsorption of water.

This sample is referred to as Sample II herein.

### EXAMPLE III

### Sample Characterization

Absorption and fluorescence spectra of sample QDs in an aqueous solution were obtained at room temperature with an Agilent™8453 UV-Vis spectrometer and a Jobin Yvon Horiba Fluorolog™ fluorescence spectrometer, respectively. The QD samples for spectral measurement were all diluted with 4-(2-hydroxyethyl)-1-piperazineethanesulfonic acid (HEPES) buffer (pH 8.5) to yield an absorbance of 0.1 at the excitation wavelength.

The fluorescence QY of the sample QDs was determined from the integrated fluorescence intensities of the sample QDs and the reference material, according to Equation (1).

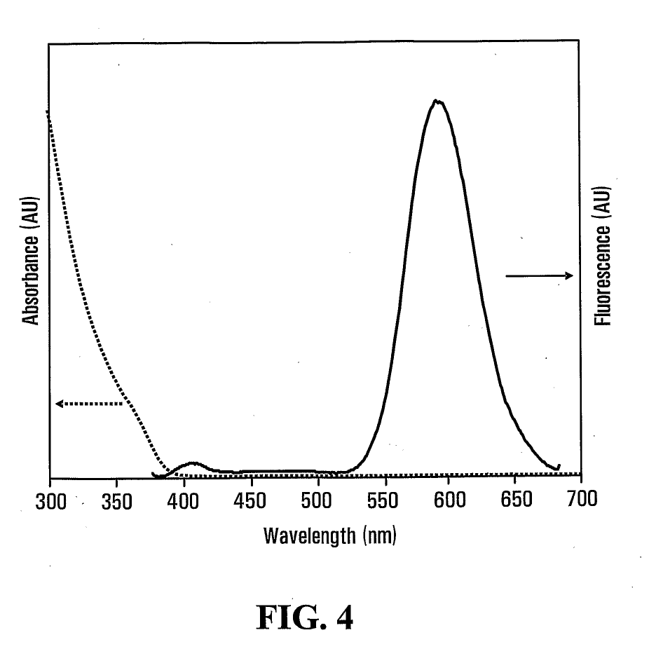

FIGS. 3 and 4 show Representative absorbance (dotted lines) and fluorescence spectra (solid lines) of Sample I (FIG. 3) and Sample II (FIG. 4). The spectra of Samples I and II were shifted towards the higher wavelengths relative to a comparison sample, which were un-doped ZnSe/ZnS quantum dots. The observed fluorescence band edge emission peaked at 490 nm for Sample I and at 590 nm for Sample II. In comparison, the emission peak for un-doped ZnSe/ZnS QDs (bandgap) was at about 370 nm.

The QY determined based on the emission measurements was about 15% for Sample I and about 20% for Sample II.

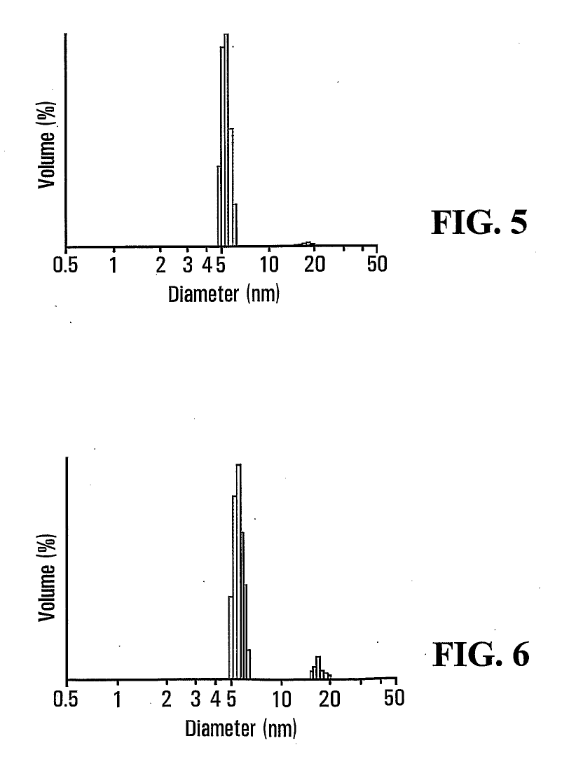

Dynamic light scattering (DLS) of the sample QDs in aqueous solutions was conducted on a BI-200SM laser light scattering system provided by Brookhaven Instruments Corporation™. The particle size distribution of the sample particles in Samples I and II was determined based on DLS measurements. Representative results are shown in FIGS. 5 (Sample I) and 6 (Sample II). The sample particles were generally spherical in shape and the diameters of the sample particles were found to be about 6 nm on average. The particle diameters shown in FIGS. 5 and 6 are overall diameters, reflecting the sum of the diameter of the core-shell crystal structure and the thickness of the GSH capping layer.

The hydrodynamic diameters of the sample QDs were also obtained using an ultrafiltration technique. Sample I and sample II QDs could pass through a membrane filter with 100K molecular weight cutoff, which corresponded to a pore size of about 6 nm.

Samples I and II QDs were resuspended and diluted in water to ppb level for elemental analysis of Zn, Mn and Se. The weight percentage of GSH was extrapolated from the known weight percentages of other elements in the samples. The elemental analysis of QDs was performed on ELAN™9000/DRC ICP-MS system. The results of the elemental analysis were used to determine the molar or weight percentages of the elements in the sample QDs.

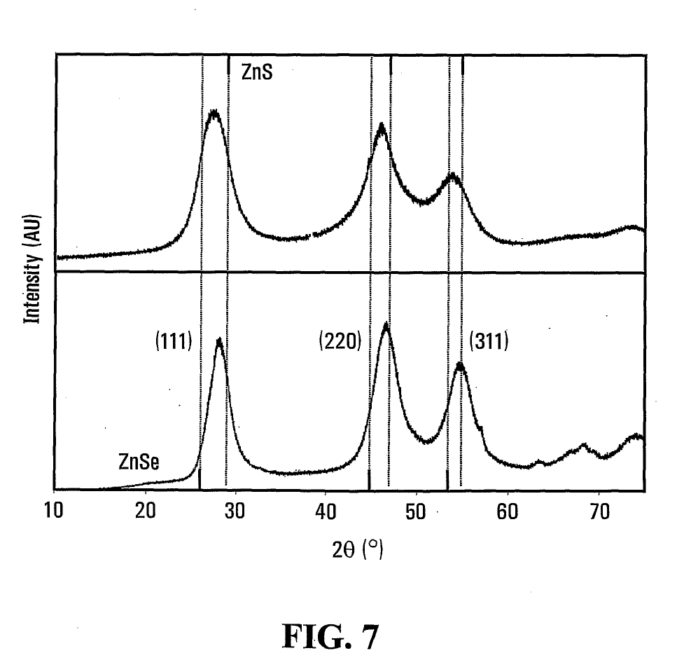

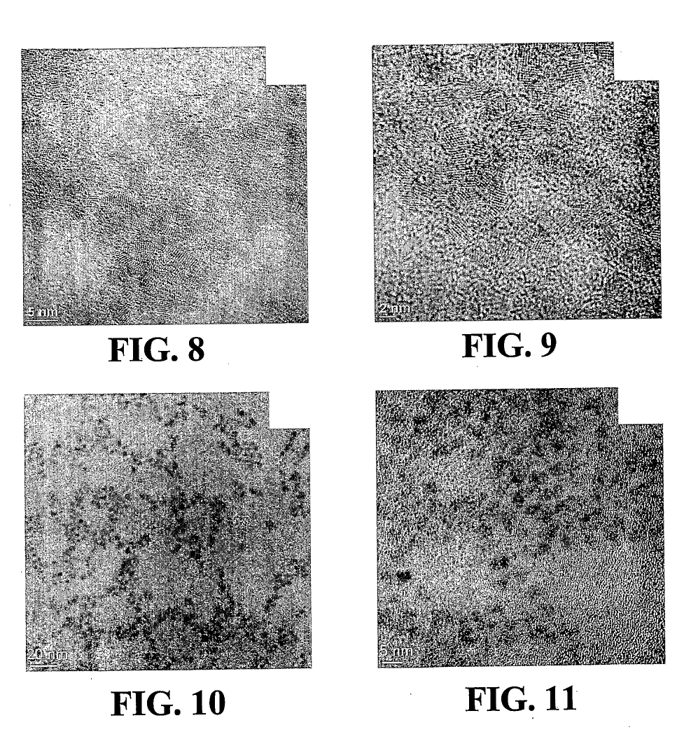

Powder X-ray diffraction (PXRD) patterns of the dried sample QD powders were obtained with PANalytical X'Pert PRO™. FIG. 7 shows representative PXRD patterns for Sample I (top) and Sample II (bottom). The PXRD patterns indicate that the sample QDs had a zinc blende cubic crystal structure. The PXRD peak positions of Samples I and II were shifted from those of pure ZnSe and ZnS crystals, which are also indicated in FIG. 7. The grain sizes of the nanocrystals in Samples I and II were calculated from the PXRD to be about 3.5 nm (Sample I) and about 4.3 nm (Sample II) respectively, from the (111) peak width using Schemer's equation. Considering the effect of composite nanocrystals on PXRD peak broadening, the actual grain size of the sample QDs should be slightly larger than the calculated value (which was based on the assumption of homogeneous crystal lattice). The actual average crystal grain size in Samples I and II was thus estimated to be about 4 to 5 nm. This estimate is consistent with the results determined based on the TEM images (see FIGS. 8, 9, 10, and 11) and DLS measurements (see FIGS. 5 and 6), taking into account of the thickness of the GSH capping layer.

High-resolution TEM of QDs was performed on FEI Tecnai™ TF-20 field emission high-resolution transmission electron microscope (200 kV). Representative TEM images of the samples are shown in FIGS. 8 (Sample I), 9 (Sample I), 10 (Sample II) and 11 (Sample II), at different magnifications.

### EXAMPLE IV

### Cell Viability

HepG2 and NIH3T3 cells were trypsinized and resuspended in Dulbecco's modified Eagle's medium (DMEM) with 10% of fetal bovine serum (FBS) and 1% of penicillin/streptomycin. The cells were seeded in 96-well microplate at a denity of 1×10⁴ cells in 150 μl of full DMEM culture medium, and kept at 37° C. and 5% of CO₂ overnight. The sample QDs were loaded in each well with a final concentration of 0, 12.5, 25, 50, 100 or 200 μg/ml; 6 duplicates were obtained for each concentration. After incubation for 48 hours, 15 μl of 1-methyltetrazole-5-thiol (MTT) (5 mg/ml) were added to each well. The medium was discarded by aspiration, and the purple MTT-formazon crystals were dissolved with 200 μl of dimethyl sulfoxide (DMSO). The plates were read for absorbance at 550 nm. The cell viability was calculated by normalizing with the results obtained with no QD loading.

For comparison purposes, MTT assay was also performed on GSH capped CdTe QDs, GSH capped Zn_{0.7}Cd_{0.3}Se alloyed QDs.

Test results showed that Sample I and Sample II QDs were less cytotoxic than GSH capped CdTe QDs in the concentration range of 5-50 μg/ml, which may be of relevance for bioimaging applications.

### EXAMPLE V

### Cell Staining

The sample QDs were used for fixed cell staining. Some sample I QDs exhibited a fluorescence emission peak at 450 nm; some sample I QDs exhibited emission peak at 500 nm; and Sample II QDs exhibited emission peak at 590 nm. At physiological pH, the negatively charged GSH-capped QDs might bind to the positively charged basic proteins of fixed cells. The macrophage RAW 264.7 cells were pre-fixed with the ice-cold methanol protocol, and then incubated with Sample I and Sample II QDs. After two hours of incubation, the cytoplasmic regions of the cells were stained in blue, green and red, respectively. The fluorescence of these doped QDs was very stable over an one hour exposure period.

Other features, benefits and advantages of the present invention not expressly mentioned above can be understood from this description and the drawings by those skilled in the art.

Although only exemplary embodiments of this invention have been described above, those skilled in the art will readily appreciate that many modifications are possible therein without materially departing from the novel teachings and advantages of this invention.

The invention, rather, is intended to encompass all such modification within its scope, as defined by the claims.

1. A process of forming a capped and doped core-shell crystal structure, comprising, sequentially:
heating a first, precursor solution comprising a mixture of a first zinc (Zn) precursor, a selenium (Se) precursor, a precursor for a dopant comprising a transition metal (M), glutathione (GSH), and water, to form a zinc selenide crystal core doped with said dopant (Zn(M)Se);
adding a second zinc precursor and GSH to said precursor solution to form a second solution, and adjusting a pH of said second solution, to favor growth of ZnS crystals;
heating said second solution to form a ZnS crystal shell on said Zn(M)Se crystal core,
wherein said GSH is added in a sufficient amount to form a layer around the crystal structure comprising said Zn(M)Se crystal core and said ZnS crystal shell on said crystal core, thus forming a GSH capped Zn(M)Se/ZnS quantum dot.

2. The process of claim 1, wherein said precursor solution is heated for about 15 to about 30 minutes, and said second solution is heated for about 2 to about 4 hours.

3. The process of claim 1, wherein a molar ratio of Zn:Se in said precursor solution is from about 10:3 to about 10:5

4. A process of forming a capped doped core-shell crystal structure, comprising:
heating a precursor solution comprising a mixture of a zinc (Zn) precursor, a selenium (Se) precursor, a precursor for a dopant, glutathione (GSH), and water, said dopant comprising a transition metal (M), a molar ratio of Zn:Se in said solution being from about 10:3 to about 10:5;
adding more zinc precursor and GSH to the heated solution,
wherein before said adding, said solution is heated for a first period sufficient to allow a zinc selenide (ZnSe) crystal core doped with said dopant
(Zn(M)Se) to form in said solution, and after said first period said solution is heated for a second period sufficient to form a ZnS crystal shell on said Zn(M)Se crystal core, and
wherein said GSH is added in a sufficient amount to form a GSH layer around the crystal structure comprising said Zn(M)Se crystal core and said ZnS crystal shell on said crystal core, thus forming a GSH capped Zn(M)Se/ZnS quantum dot.

5. The process of claim 4, wherein said first period is from about 15 to about 30 minutes, and said second period is from about two to about four hours.

6. The process of claim 3, wherein said molar ratio of Zn:Se in said precursor solution is about 5:2.

7. The process of claim 1, wherein a pH of said precursor solution is from about 10 to about 12.

8. The process of claim 1, wherein said precursor solution is prepared by adding said selenium precursor to an aqueous solution, said aqueous solution comprising a mixture of said zinc precursor, said precursor for said dopant, and GSH.

9. The process of claim 1, wherein said heating comprises heating at a temperature below the boiling temperature of water.

10. The process of claim 9, wherein said temperature is from about 95 to about 99° C.

11. The process of claim 1, wherein said zinc precursor comprises zinc chloride, said selenium precursor comprises sodium hydroselenide, and said precursor for said dopant comprises a metal chloride.

12. The process of claim 1, wherein a molar ratio of Zn to said dopant in said precursor solution is about 50:1.

13. The process of claim 1, wherein said transition metal is copper.

14. The process of claim 13, wherein said GSH capped quantum dot has a fluorescence quantum yield of about 15%.

15. The process of claim 1, wherein said transition metal is manganese.

16. The process of claim 15, wherein said precursor solution further comprises a sulfur precursor, and a molar ratio of Zn:Se:S in said precursor solution is about 5:2:3.

17. The process of claim 16, wherein said sulfur precursor comprises sodium sulfide.

18. The process of claim 15, wherein said GSH capped quantum dot has a fluorescence quantum yield of about 20%.

19. The process of claim 1, wherein said transition metal comprises copper, manganese, europium, lead, or silver.

20. The process of claim 1, wherein said crystal structure is generally spherical and has a diameter of about 4 to about 5 nm.

21. The process of claim 1, wherein said GSH capped quantum dot is generally spherical and has a diameter of about 6 nm.

22. The process of claim 1, wherein said adding comprises adding zinc precursor and GSH at a rate selected to favor growth of ZnS crystals on said Zn(M)Se crystal core over growth of free ZnS crystals.

23. The process of claim 22, wherein said rate is about 1 to about 5 ml/min.
